(19) United States
(12) Patent Application Publication
(10) Pub. No.: US 2004/0080402 A1
(43) Pub. Date: Apr. 29, 2004

(54) Windshield wiper spoiler structure

(76) Inventor: Yung-Ho Lee, Sanchung City (TW)

Correspondence Address: Keith Kline, PRO-TECHTOR INTERNATIONAL SERVICES, 20775 Norada Court, Saratoga, CA, 95070-3018, US

(21) Appl. No.: 10/280,549

(22) Filed: Oct. 24, 2002

(51) Int. Cl. B60Q 1/00

(52) U.S. Cl. 340/425.5

(57) ABSTRACT

A windshield wiper spoiler structure is constructed to include a windshield wiper spoiler, and a visual signal source fixedly located on the windshield wiper spoiler and electrically connected to the battery power circuit of the motor vehicle in which the windshield wiper spoiler structure is installed and adapted to produce a visual warning signal when turning on the windshield wiper spoiler.

### BACKGROUND OF THE INVENTION

1. Field of the Invention

The present invention relates to a windshield wiper for motor vehicle and, more particularly to a windshield wiper spoiler structure, which produces a visual warning signal when turning on the windshield wiper spoiler.

2. Description of the Related Art

When driving a motor vehicle in a raining day or at dark, the driver may be unable to see the antecedent cars or the cars coming from the opposite lane. When driving a motor vehicle during raining or at dark, a traffic accident tends to occur. In order to prevent a traffic accident when driving a motor vehicle during raining or at dark, the driver usually will turn on the headlamps or flash the turn signal lamps. However, a motor vehicle driver may forget to turn on the headlamps or flash the turn signal lamps when driving a motor vehicle during raining or at dark. In this case, a traffic accident may occur easily.

### SUMMARY OF THE INVENTION

The present invention has been accomplished under the circumstances in view. It is the main object of the present invention to provide a windshield wiper spoiler structure, which automatically produces a visual warning signal to the driver of the car going in front or the car coming from the opposite lane when the windshield wiper spoiler turned on. According to one aspect of the present invention, the windshield wiper spoiler structure comprises windshield wiper spoiler, and a visual signal source fixedly located on the windshield wiper spoiler and electrically connected to the battery power circuit of the motor vehicle in which the windshield wiper spoiler structure is installed and adapted to produce a visual warning signal when the windshield wiper spoiler turned on. According to another aspect of the present invention, the visual signal source is comprised of a casing, a lighting circuit assembly mounted within the casing and electrically connected to the power supply of the motor vehicle. Therefore, when the windshield wiper spoiler turned on, the lighting circuit assembly is driven to produce a visual warning signal.

### BRIEF DESCRIPTION OF THE DRAWINGS

FIG. 1 is an exploded view of a windshield wiper spoiler structure according to the present invention.

FIG. 2 is an elevational perspective view of the present invention.

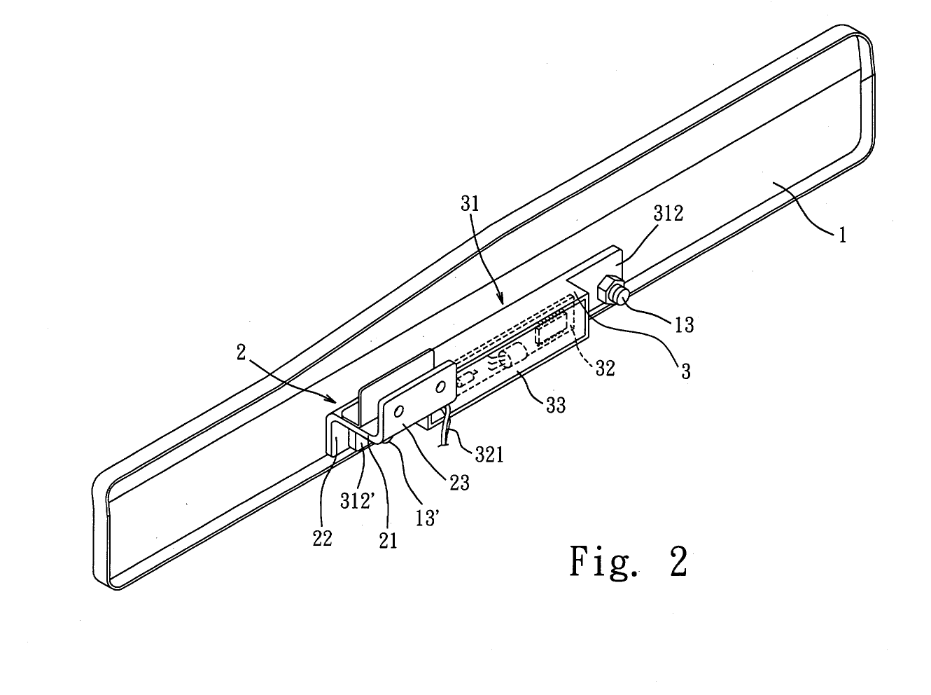

FIG. 3 is another elevational view of the present invention when viewed from another angle.

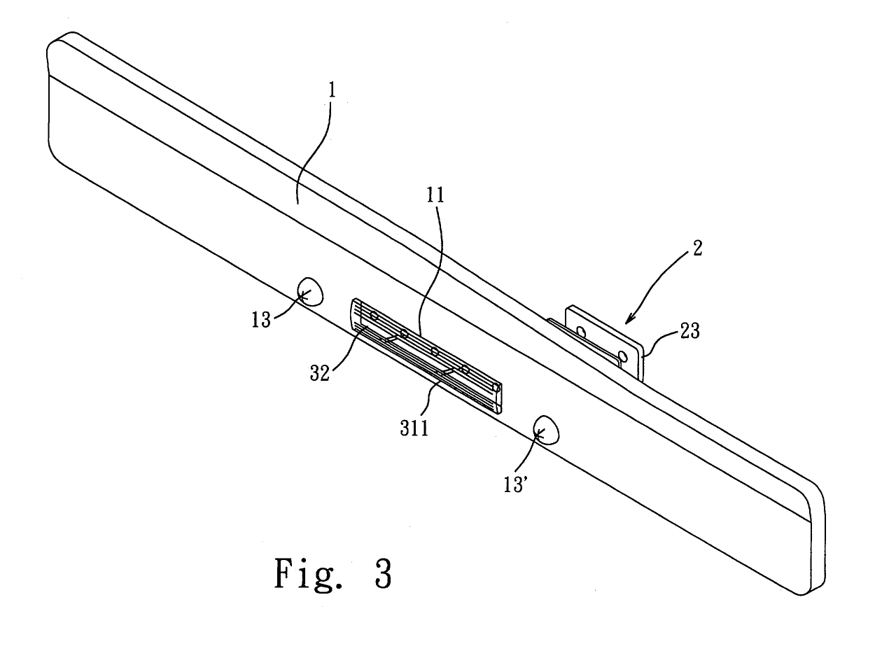

FIG. 4 is a schematic sectional view of the present invention, showing the lighting circuit assembly started.

FIG. 5 is an applied view of the present invention, showing the wiper blade complete moved over the windshield, the lighting circuit assembly turned on.

FIG. 6 is a circuit block diagram of the lighting circuit assembly for the visual signal source of the windshield wiper spoiler structure according to the present invention.

### DETAILED DESCRIPTION OF THE PREFERRED EMBODIMENT

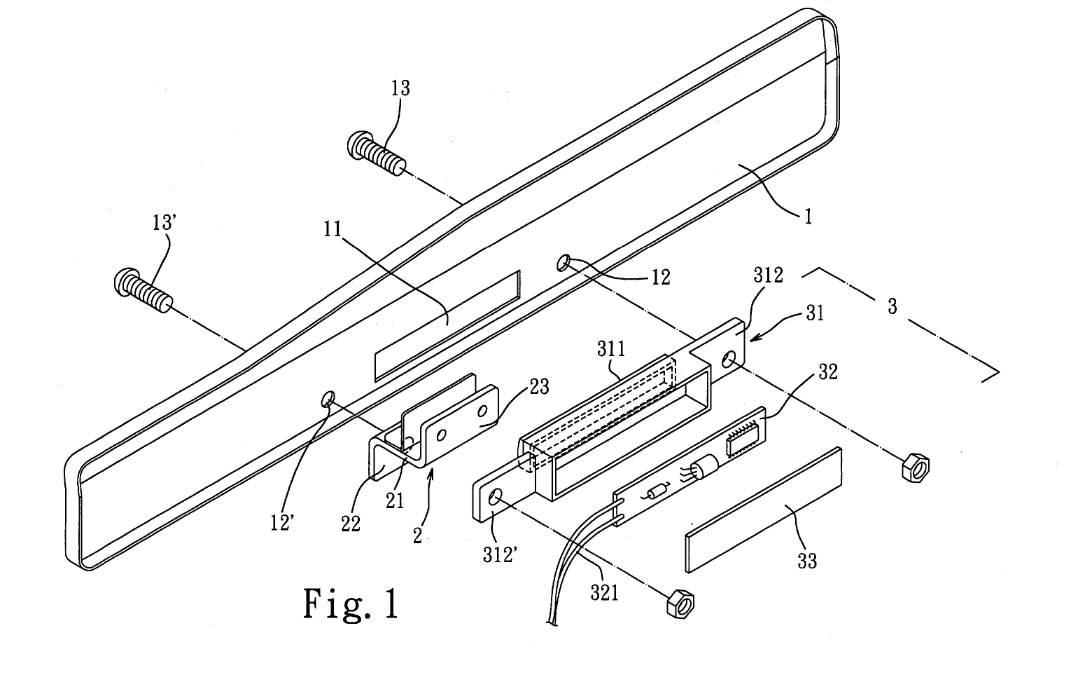

Referring to FIGS. 1˜3, a windshield wiper spoiler structure in accordance with the present invention is shown comprised of a windshield wiper spoiler 1, a connector 2 provided at the windshield wiper spoiler 1, and a visual signal source 3 installed in the windshield wiper spoiler 1. When turned on power supply, the visual signal source 3 provides a visual warning signal (flashes or emits light) to the cars going in front or the cars coming from the opposite lane.

The windshield wiper spoiler 1 is of the known art, having a watertight window 11, and two mounting holes 12 and 12′ disposed at two sides of the watertight window 11. Fastening members, for example, screws 13 and 13′ are installed in the mounting holes 12 and 12′ to fixedly secure the connector 2 and the visual signal source 3 to the inside of the windshield spoiler 1.

The connector 2 comprises a base 21, a first mounting portion 22 extended from one end of the base 21 and fixedly fastened to the windshield wiper spoiler 1, and a second mounting portion 23 extended from the other end of the base 21 for fastening to the wiper arm complete (not shown).

The visual signal source 3 comprises a casing 31, a lighting circuit assembly 32 mounted inside the casing 31, and a cover 33 sealed to the casing 31 to hold the lighting circuit assembly 32 inside the casing 31. The casing 31 comprises a lens 311 fitting the window 11 of the windshield wiper spoiler 1, and two mounting flanges 312 and 312′ respectively extended from two opposite lateral sides thereof and respectively fastened to the mounting holes 12 and 12′ of the windshield wiper spoiler 1 by the screws 13 and 13′. The lighting circuit assembly 32 has lead-out wires 321 respectively connected to the positive and negative terminals of the power supply of the motor vehicle (not shown) in which the invention is installed. The lighting circuit assembly 32 can be controlled to flash or steady light subject to a predetermined control program.

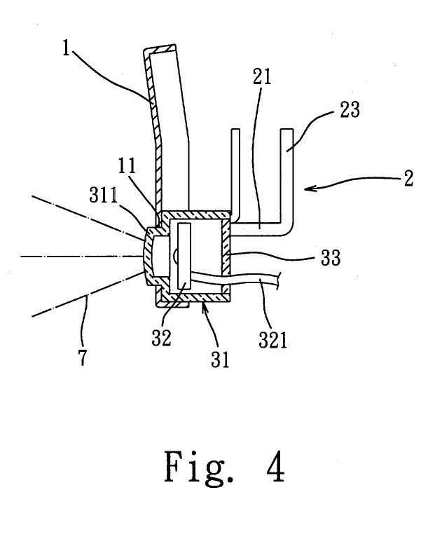

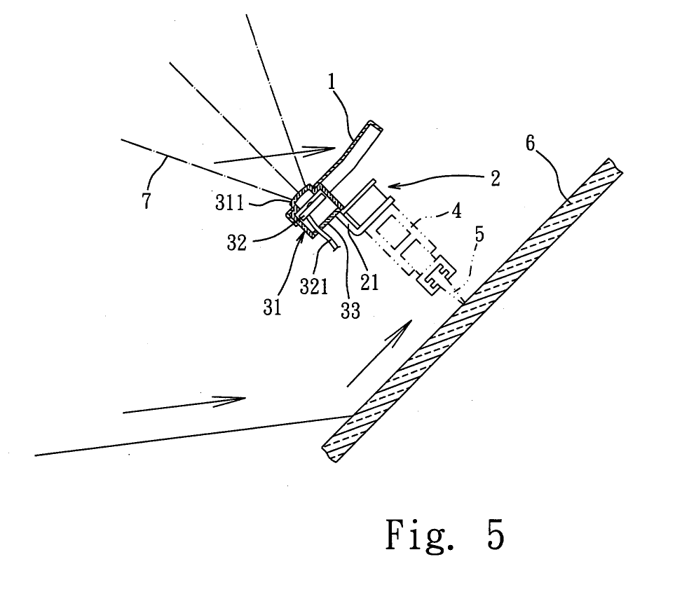

Referring to FIGS. 4 and 5, after installation of the wiper arm in the connector 2 and installation of the present invention in the corresponding windshield wiper motor assembly of the motor vehicle, the lead-out wires 321 of the visual signal source 3 are respectively connected to the positive and negative terminals of the power circuit of the motor vehicle. When turned on the windshield wiper spoiler 1 and the windshield wiper motor assembly of the motor vehicle to move the wiper arm, the blade 5 of the wiper blade complete 4 is moved with the wiper blade complete 4 and the windshield wiper spoiler 1 back and forth on the windshield 6 to remove rainwater from the windshield 6, and at the same time the lighting circuit assembly 32 of the visual signal source 3 emits light 7 through the lens 311 and the window 11 to give a visual warning signal to the cars going in front or the cars coming from the opposite lane.

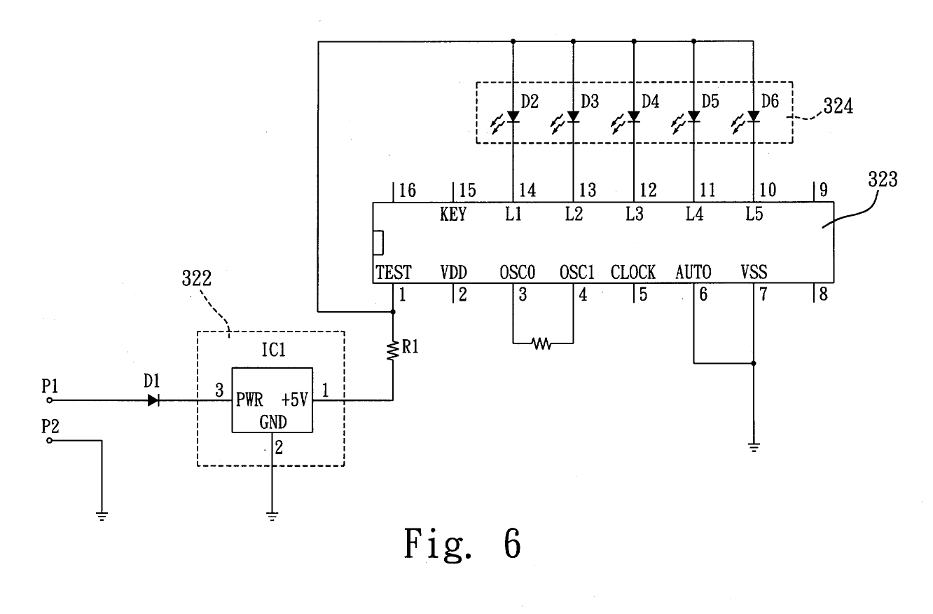

Referring to FIG. 6, the light circuit assembly 32 comprises a voltage stabilizer unit 322, a control unit 323, and a display unit 324. The voltage stabilizer unit 322 rectifies input power and provides a stabilized voltage to the control unit 323 and the display unit 324. When the light circuit assembly 32 turned on, the control unit 323 controls the display mode of the display unit 324 subject to the program built therein. The display unit 324 can be formed of a set of light emitting diodes, lamp bulbs, or electroluminescent lamps.

Further, a sealing strip may be sealed between the casing 31 and the cover 33 to keep the inside space of the casing 31 against rainwater. Alternatively, a bonding resin may be molded in the casing 31 over the light circuit assembly 32 to protect the light circuit assembly 32 against rainwater. Other suitable methods, such as the use of supersonic bonding to seal the casing 311 and the cover 33 together to keep the lighting circuit assembly 32 against rainwater can also be accepted.

A prototype of windshield wiper spoiler structure has been constructed with the features of FIGS. 1˜6. The windshield wiper spoiler structure functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A windshield wiper spoiler structure connected to the power supply of a motor vehicle and adapted to move a wiper blade complete alternatively back and forth on the windshield of the motor vehicle, the windshield wiper spoiler structure comprising
a windshield wiper spoiler, said windshield wiper spoiler having a window; and
a visual signal source fixedly located on said windshield wiper spoiler corresponding to said window and electrically connected to the power supply of the motor vehicle in which the windshield wiper spoiler structure is installed and adapted to output a visual signal through said window when the power supply of the motor vehicle turned on to move said windshield wiper spoiler and said wiper blade complete.

2. The windshield wiper spoiler structure as claimed in claim 1, wherein said windshield wiper spoiler has two mounting holes at two sides of said window for the mounting of said visual signal source.

3. The windshield wiper spoiler structure as claimed in claim 1, wherein said visual signal source comprises a casing, a lighting circuit assembly mounted within said casing, and a cover sealed to said casing to hold said lighting circuit assembly inside said casing.

4. The windshield wiper spoiler structure as claimed in claim 3, wherein said casing comprises two mounting flanges extended from two opposite lateral sides thereof and adapted for fastening to said windshield wiper spoiler.

5. The windshield wiper spoiler structure as claimed in claim 3, further comprising a bonding resin molded in said casing over said light circuit assembly to protect said light circuit assembly against rainwater.

6. The windshield wiper spoiler structure as claimed in claim 3, further comprising a sealing strip sealed between said casing and said cover to keep the inside space of said casing against rainwater.

7. The windshield wiper spoiler structure as claimed in claim 3, further comprising a supersonic bonding to seal said casing and said cover together to protect said lighting circuit assembly against rainwater.

8. The windshield wiper spoiler structure as claimed in claim 1, further comprising a connector fixedly fastened to said windshield wiper spoiler and adapted to secure a wiper blade complete to said windshield wiper arm.

9. The windshield wiper spoiler structure as claimed in claim 7, wherein said connector comprises a base, a first mounting portion extended from one end of said base and fixedly fastened to said windshield wiper arm, and a second mounting portion extended from an opposite end of said base and adapted for securing a wiper blade complete.

10. A windshield wiper spoiler structure comprising:
a control unit; and
a visual signal source controlled by said control unit to produce a visual warning signal.

11. The windshield wiper spoiler structure as claimed in claim 10, wherein said visual signal source is comprised of at least one light emitting diode.

12. The windshield wiper spoiler structure as claimed in claim 10, wherein said visual signal source is comprised of at least one lamp bulb.

13. The windshield wiper spoiler structure as claimed in claim 10, wherein said visual signal source is comprised of at least one electroluminescent lamp.

14. The windshield wiper spoiler structure as claimed in claim 10, further comprising a voltage stabilizer unit adapted to provide a stabilized working voltage to said control unit and said display unit.
